(19) United States
(12) Patent Application Publication
(10) Pub. No.: US 2006/0182566 A1
(43) Pub. Date: Aug. 17, 2006

(54) Carriage platform assembly

(76) Inventor: Thomas L. Russo, Rutland, VT (US)

Correspondence Address: Thomas L. Russo, 7 Avenue D, Rutland, VT, 05701, US

(21) Appl. No.: 11/034,650

(22) Filed: Jan. 13, 2005

(51) Int. Cl. B62B 1/06

(52) U.S. Cl. 414/444

(57) ABSTRACT

The invention assist moving articles with the application of strapping material in combination with a Carriage Platform that secure wheel or wheel like structures to a designated article creating an assembly to assist in temporary or extended article mobility.

### FIELD OF THE INVENTION

The filed of invention applies an apparatus that will assist moving articles with a system, device or assembly that can provide temporary or extended article mobility.

### BACKGROUND OF THE INVENTION

Article herein refers to any object, package, item, tool, equipment, groups of materials, furniture, appliances or any other three dimensional form, structure or container.

When articles are moved in commercial or residential situations they can employ a number of mobile assist apparatus. These varying apparatus are described as Hand Trucks Vertical, Exhibit A, Hand Truck Horizontal, Exhibit B, Rectangular and Square dollies, Exhibit C, as well as Triangular and Appliance dollies, Exhibit D, Exhibit E. These mobility devices have their place in article mobility. But each has limitations that do not allow them to be used in all situations.

Hand Truck Vertical, Exhibit A, has a physical frame that supports an axle-through wheels configuration. This physical frame structure limits the type, size and the amount of articles that can receive mobility. The frame itself must be considered in article movement as it adds to the article's dimensions. Mobility with this apparatus requires a tip back transport angle and article weight transfer to provide movement.

Hand Truck Horizontal, Exhibit B, has a physical frame that supports an axle through wheels configuration as well as swivel wheels to aid in maneuvering its horizontal frame format. This physical frame structure limits the type, size and the amount of articles that can receive mobility. The frame itself must be considered in article movement as it adds to the article dimensions.

Square and rectangular dolly, Exhibit C, has a physical frame that supports a format of straight and swivel wheel configurations or all straight or all swivel wheel configurations. This physical frame structure limits the type, size and the amount of articles that can receive mobility. The frame itself must be considered in article movement as it adds to the article dimensions. Mobility with this apparatus performs best when the article receiving mobility rest its weight and a flat surface directly on the dolly frame to provide movement.

Triangular dollies, Exhibit D, have a physical frame that supports a format of a swivel wheel configuration. This physical frame structure limits the type, size and the amount of articles that can receive mobility. The frame itself must be considered in article movement as it adds to the article dimensions. Mobility with this apparatus performs best when the article receiving mobility rest its weight and a flat surface directly on the dolly frame to provide movement.

Appliance dolly, Exhibit E, has a physical frame that supports an axle through wheels configuration. This physical frame structure limits the type, size and the amount of articles that can receive mobility. The frame itself must be considered in article movement as it adds to the article dimensions. Mobility with this apparatus requires a tip back transport angle and article weight transfer to provide movement.

It is known, therefore, that articles needing mobility can employ one of the above mentioned inventions, illustrated in Exhibits A, B, C, D, E, in all their varying forms and structures. But with the unlimited design and complexity of shapes, sizes, weight and configurations of an article needing mobility many if not all of the traditional mobility apparatus may need to be available and applied to provide the necessary mobility.

Limitations are designed into all devices and apparatus that provide article mobility. Traditional Hand Trucks as they represent the upright frame with an axle wheel configuration that constitutes the main carrying component, their frame and axle assembly must be considered in its transport as a unit or device of mobility assist. Hand Truck also requires the weight transfer of a portion of the article to be moved to the single operator. as well as requiring Transport Angulations to assist mobility.

Traditional Article Dollies represent a horizontal frame format with wheels mounted directly to this frame structure often requiring a more exacting placement of the article needing mobility in order to provide movement

Moreover all of the above-described mobility apparatus are themselves physical structures that must be considered as they provide mobility. In addition, they each require storage and transport space that may preclude them from being considered for mobility where both storage space and transport space are at a premium.

The mobility apparatus described herein, and throughout the prior art have been faced with a number of design challenges in order to provide mobility to a wide range of article types, sizes, weights and configurations.

It is thus readily apparent that there exists a need for a mobility apparatus, which is satisfied by the present invention as described herein, for a reliable, efficient, adjustable mobility apparatus, with multiple configurations and unlimited capacity for article type, shape, size, weight and configurations. The present invention meets these requirements with a simple design that is readily and conveniently manufactured from inexpensive materials. The object of the invention is thus relatively simple, by providing a frameless apparatus, a more flexible system is created by the assembly describe herein as the Carriage Platform Assembly, FIG. 1, 1B, 3, that can be used for a wider range of articles needing mobility. With its multiple embodiments the present invention can provide mobility in all environments where article movement is required.

### SUMMARY OF THE INVENTION

The system of the inventions is a carriage platform, FIG. 3, that allows a single wheel, FIG. 5, or wheel like element to assist article mobility as it provides a formed structure that is secured to the article, FIG. 8, requiring mobility with a banning or strapping device, FIG. 1, 1B, 7, 7B, that develops the article requiring mobility as the custom frame work of the invention, FIG. 2, 8B, 8C, 23D,25,26, 27,28,29, of the Carriage Platform Assembly, FIG. 1B.

It is therefore the direction of this invention a Carriage Platform Assembly, FIG. 1, 1B, that incorporates a carriage platform, FIG. 3, in combination with strapping material that secure wheel or wheel like structures, FIG. 4, to a designated article, FIG. 23, 23B,23C providing a flexible and custom mobility without adding significant weight or dimension to the article needing mobility.

The application of a strapping element with a Carriage Platform provides several beneficial attributes allowing mobility to a wider range of articles. Strapping or banding, FIG. 7, 7B, can be applied to any article type, shape, or size. All strapping or banding elements, materials and devices currently known as well as those developed in the future can be applied to the Carriage Platform, that will secure the article needing mobility to the wheel or wheel-like structure providing mobility, FIG. 8B,8C.

It is known, therefore, to provide mobility to an article, that the article will need to be completely lifted or at least partially lifted to be moved by a traditional mobility device and will use the structure of said device to hold the article in order to move an article. In the present invention the article requiring mobility provides its own structure with the carriage platform placed under an edge or a corner (s) allowing wheels or wheel-like structures to provide mobility.

The present invention can provide mobility using weight transfer. Weight Transfer is required with the use of a traditional Hand Truck and Appliance Hand Truck, Exhibit A, E, putting a portion of the article weight on the single person operating the Hand Truck. In the present invention an article that derives its mobility from the a single carriage platform assembly, FIG. 29, or a double carriage platform, FIG. 6,21, will exercise the properties of weight transfer to aid in its mobility, weight transfer is accomplished by lifting one end of the article and allowing the end supporting the wheels to move along the surface. With the present invention Weight transfer can be reduced or eliminated when applying an additional Carriage Platform assembly, FIG. 2,22, 23D 25,26, 27,28, 29B, distributing the article weight over additional carriage platforms. Distributing the article weight will provide for single or multiple operator force and direction to support mobility. Operation is a simple pushing or pulling motion of the article along the intended surface, without the requiring the operator to carry a portion of the transferred weight. Directional changes are also facilitated by a simple push or pull motion by one or more operators assisted by the multi directional swivel wheels attached to the carriage platform. Because there is no framed structure that is responsible for moving an article with the present invention allowing several operators to apply force or direction to all edges of the article needing mobility.

In the present invention article mobility is provided with no structured frame containing and connecting the rolling mechanism, FIG. 23D, 1B, that would be responsible for increasing the Article's Perimeter dimensions by its frame size as in the traditional Hand Truck, and Dolly apparatus, Exhibits A, B, C, D, E, the assembled wheel structures and their supporting frame work add to and extend the article requiring mobility perimeter space, By extending the article perimeter mobility may be reduced and movement through narrow paths and corridors difficult if not impossible.

Transport Angulations would further impede movement with traditional Hand Truck apparatus. Transport Angulation is referring to the angle required to provide movement of an article requiring mobility as it is moved around and through corners and tight turning radius, in addition to identifying frame dimensions of the traditional mobility apparatus, Exhibit A, B, C, D, E, articles will require the traditional hand truck to provide a transport angle, in FIG. 30 the article to be moved increases its transport space requirement in several directions in order to be moved by a traditional Hand Truck, in FIG. 30 the present invention does not require the transport angle to provide mobility and therefore does not increase its transport space requirement of the article being moved.

The present invention accomplishes this improved movement without adding a frame dimension to the article requiring mobility, due to the strapping or banding device being used to hold the carriage platform and its wheel or wheel like structure around the article perimeter. This application of strapping or banding device holding the carriage platform also allows for mobility security of the article. With the carriage platform and its wheel or wheel like structures firmly secured around the article, there is less opportunity for the article to slip off during movement or be left behind when an article is lifted up stairs or over a curbs or barriers, FIG. 24,24B,24C. The same system of strapping or banding device can be applied in unlimited configurations, FIG. 8B,8C, forward, back, crisscross, around the top, around the bottom, up the sides and around articles with varying shapes and textures or around articles with little or no definitive shape, such as a tarp full of leaves and twigs, FIG. 27, or multiple articles with many surface planes and angles, FIG. 28, as well as a single plane with multiple pieces, FIG. 26. The strapping portion of the invention provides hand holding areas along the articles perimeter, to assist with mobility. Additionally, strapping material can form auxiliary handles to help with the push, pull motion used to create mobility and provide direction. FIG. 7B. This strapping system forms a flexible, custom fitting mobility component that secures the carriage platform without marring or damaging the article it is holding. Several carriage platforms can be placed along a single length of strapping, providing mobility in several directions if needed, with an auxiliary carriage platform, FIG. 20C, attached to a select carriage platform, FIG. 20, movement up or down a stair case can be assisted with the auxiliary wheel riding along the stair raisers, reducing the need for article lifting or to prevent friction damage on an article pulled up or placed down a stair case.

Carriage platforms have an unlimited format array, FIG. 3,9,10,11,12,13,14,15,16,17,18, Illustrate just a few applications of carriage platforms with wheel and wheel like structures, but by no means suggest all the possible applications available within this invention. These carriage platforms do provide several grouping that can be considered. Carriage platforms can be affixed permanently with its wheel structure, FIG. 10,11,14, to the strapping component or removed with the proper tools. Carriage Platforms can also be separate and applied to strapping with no tools before strapping is applied to an article, or after strapping is already applied to an article, there are unlimited designs that allow the Carriage Platform with its wheel structure to be secured to strapping when mobility is required, or removed from the strapping when mobility is no longer needed, FIG. 1,3,4,9,12,13, 15,16, illustrate several formats of loops, snaps, and locks that will allow this simple removable Carriage Platform with its wheel structure, but by no means represents all the possible applications. The present invention also allows the Carriage Platform to be placed on the strapping component without its wheel structure, FIG. 17,18, and the wheel structure, FIG. 5, can be applied when mobility is required. This application can assist article storage and when mobility is required simply attach the wheel structures. This embodiment of a carriage platform can be produced inexpensively and disposed of when the strapping is removed from the article, allowing the wheel structures to be used again.

The system of the inventions is a carriage platform that allows a single wheel or wheel like element to assist article mobility as it provides a flexible structure that is secured to the article requiring mobility with a banning or strapping device that develops the article requiring mobility as its own custom frame work that will allow mobility, FIG. 2, with the Carriage Platform Assembly, FIG. 1B. In summary the present invention provides secure mobility to articles with:
Corner to corner application provides a custom fit to the Carriage Platform assembly. Adjustment can be achieved by placing a carriage platform along the length a strapping material that best fit the article to be moved.
Stair climbing assist provided with a Carriage Platform assembly with an auxiliary Carriage Platform wheel or wheel like structure to assist vertical movement up or down stairs
Non-Skid Surface carriage platform provide surface area that can be treated with non-skid materials, or design elements that supports a non-skid holding pattern such as perforations, raised surface topography, etched surface design orientation.
Non-Marring Material Carriage platforms can be manufactured in all formable material currently known and any formable material developed in the future. Materials such as wood, wood composites, paper, glass, fiber glass, fibrous compounds, fibrous matting, metals, plastics, resins, rubber, in a variety of forms, extruded, sheets, rods, cast, forged, solid and semi-solids
Frameless the Carriage Platform assembly requires no ridge frame to allow an article to be held in place on the assembly while being moved
Axle free allows the wheel base of the Carriage Platform assembly to be extended or reduced as the article's dimensions demands.
Tip Back to allow movement in traditional Hand Truck design is not required with a corner to corner carriage platform arrangement, mobility requires a directional push, forward, back, side to side, diagonally or any of the 360 degrees allowing complete movement of the articles carried on a carriage platform assembly. Traditional Hand Trucks can move forward and back but can not move side to side, diagonally or with all of the 360 degrees. Several dollies can move within 360 degree directions but become encumbered with grade changes, movement that require tip back are unable to be accomplished with dolly centered under the article requiring mobility where the article becomes surface bound when edges and or corners contact the ground while trying to maneuver using a tip back profile.
The invention Assembly continues to function through grade changes

Because of the corner to corner design with the security associated with strapping bound carriage platform with wheel assemblies, the strapping bound Carriage Platform Assembly feature supports:
Edge to edge application provides for a Carriage Platform where each edge of the article to be moved contains a Carriage Platform
Multiple or auxiliary carriage platforms added for additional support
Connectivity allowing groups of articles to be tethered together and provide group movement
Flexibility is a key element, to the number of Carriage Platforms, number of strapping layouts, size and shape of the carriage platforms, size and shape of the wheels and wheel like structure.
The Article forms the structure allowing the Carriage Platform to provide mobility; the article to be moved develops the apparatus as a custom mobility device.
Custom fit allows odd or irregular shapes to be moved
Storage articles can be stored with Carriage Platforms in stationary or rolling positions
Minimal storage of the Carriage Platform assemblies allow them to be carried at all times with reduced storage to performance ratio. Example four Carriage platforms with wheel and strapping assembly stored in a 6″×8″×4″ area could provide mobility assist to a package 60″×60″×60″
Combination provide select and custom applications, one Carriage Platform assembly will provide mobility assist, unlimited number of Carriage platform assemblies can be added to an article to further assist mobility
Can be used in conjunction with traditional mobility
Custom application creates multiple applications of a single assembly

The object of the invention is to provide a system of temporary or extended article mobility, the inventions is a carriage platform assembly that allows a single wheel or wheel like element to assist article mobility as it provides a formed structure that is secured to the article requiring mobility with a banning or strapping device that develops the article requiring mobility as the custom frame work, FIG. 2, of the Carriage Platform Assembly, FIG. 1B.

### BRIEF DESCRIPTION OF THE DRAWINGS

The foregoing objects and other advantages of the present invention will be more fully understood from the following detailed description and reference to the appended drawings, wherein:

FIG. 1 is a perspective view of the components making up a two carriage platform assembly with wheel structures and strapping device.

FIG. 1B is a perspective view of a two carriage platform assembly placed together as if they were to surround an article requiring mobility.

FIG. 2 is a perspective view of an article to be moved using two Carriage Platform Assemblies with their wheel structures and strapping devices.

FIG. 3 is a perspective view of a carriage platform illustrating its horizontal platform 1, vertical platform 2, wheel structure 3, horizontal strapping connection, vertical strapping connection 5, and adjustable/removable vertical platform connection 6.

FIG. 4 is a perspective view of a carriage platform illustrating its horizontal platform 1, vertical platform 2, wheel structure 3, horizontal strapping connection, vertical strapping connection 5, adjustable/removable vertical platform connection 6 and strapping positioning 7.

FIG. 4B is a side view of a carriage platform illustrating its horizontal platform 1, vertical platform 2, wheel structure 3, horizontal strapping connection, vertical strapping connection 5, adjustable/removable vertical platform connection 6 and strapping positioning 7.

FIG. 5 is a perspective view of a wheel structure.

FIG. 6 is a see through view of an article with one strapping device supporting two carriage platforms, in this position on the article can be pulled over the wheel structure placement and moved like a hand truck apparatus by transferring some of the article weight.

FIG. 7 is a perspective view of a section of strapping material that would make up the strapping device, it illustrates a closing device that might be used to tighten the strapping around the article needing mobility

FIG. 7B is a perspective view of several auxiliary loop handles that are formed or could be formed with the strapping material.

FIG. 8 is perspective view of a piece of furniture that represents an article that requires mobility

FIG. 8B is perspective view of a piece of furniture that represents an article that requires mobility with the Carriage Platform Assembly connected front to back as one option to provide movement.

FIG. 8C is perspective view of a piece of furniture that represents an article that requires mobility with the Carriage Platform Assembly connected side to side as an other option to provide movement.

FIG. 9 is a front and side view of a carriage platform formed of rod material providing an extended vertical platform with two vertical strapping connections and a sled like edge to assist in pulling and article up stairs or letting an article down stairs.

FIG. 10 is front and side view of a low profile carriage platform that is designed to be attached to a strapping material allowing the strapping to move through the space between the horizontal platform and the wheel structure creating a sliding effect providing adjustability along the strapping length. The vertical platform helps stabilize the carriage platform assembly as it holds the carriage and wheel assembly on the article edges, reducing slippage as an article is pushed along.

FIG. 11 is the same carriage platform assembly arrangement described in FIG. 10 the only difference is a different wheel structure. This is a front and side view of a low profile carriage platform that is designed to be attached to a strapping material allowing the strapping to move through the space between the horizontal platform and the wheel structure creating a sliding effect providing adjustability along the strapping length. The vertical platform helps stabilize the carriage platform assembly as it holds the carriage and wheel assembly on the article edges, reducing slippage as an article is pushed along.

FIG. 12 is a front, side and adjusted plan view of the carriage platform. To help illustrate that a bent rod carriage platform can be effective in a low profile allowing a slip on reverse side strapping connection, in this embodiment the carriage platform with its wheel structure can be removed from a strapping device or connected to a strapping device without any tools, just by slipping the strapping into the strapping connections on both the horizontal and vertical platforms.

FIG. 13 is a front, and side view of the carriage platform created of a formed material providing a permanent horizontal and vertical platform angle position. To help illustrate that a formed carriage platform can be effective in a low profile allowing a slip on reverse side strapping connection, in this embodiment the carriage platform with its wheel structure can be removed from a strapping device or connected to a strapping device without any tools, just by slipping the strapping into the strapping connections on both the horizontal and vertical platforms.

FIG. 14 is the same low profile carriage platform assembly as that described in FIGS. 10 and 11 with a different wheel structure.

FIG. 15 is a perspective view of a rod formed horizontal and vertical platforms that provide an attachment for a strapping or banding material with a cylindrical profile, all banding and strapping material can be used in the present invention.

FIG. 15B illustrates a cylindrical banding or strapping material in place in the carriage platform of FIG. 15.

FIG. 16 is a front and side view of a carriage platform in a semi circle shape to help illustrate that the carriage platform can be created with an unlimited number of shapes and sizes.

FIG. 16B provides a modified top view of the semi circle carriage platform assembly.

FIG. 16 C shows FIG. 16 in a perspective view with its strapping connection in the horizontal and vertical platforms

FIG. 16D is a perspective view of the carriage platform assembly in FIG. 16C attached to a second carriage platform as they would be positioned under and article requiring mobility.

FIG. 17 is a perspective view of a carriage platform that is designed for a removable wheels and wheel-like structures, allowing the carriage platform to be left in place around the article without its wheel structure when mobility is not required, held in place by the strapping or banding device, when mobility is required a wheel structure is inserted in the platform.

FIG. 17B is a perspective view of a carriage platform with a wheel structure that can be inserted to provide mobility

FIG. 17C is a perspective view of a carriage platform with a wheel structure inserted to provide mobility, and a perspective view with a wheel structure being removed form the Carriage Platform.

FIG. 17D is a perspective view of a Carriage Platform with a wheel structure inserted on a vertical plane, the invention can provide mobility on the horizontal plane to move an article across a surface, and on the vertical plane to help provide movement up or down stairs or moving an article vertically to assist mobility.

FIG. 18 is a perspective view of another carriage platform that is designed for a removable wheels and wheel-like structures, allowing the carriage platform to be left in place around the article without its wheel structure when mobility is not required, held in place by the strapping or banding device, when mobility is required a wheel structure is inserted in the platform. The invention lends itself to unlimited designs or embodiments that allow a wheel structure to be attached to an article needing mobility.

FIG. 19 is a perspective view of an adjustable Carriage Platform with an attached wheel structure.

FIG. 19B is a perspective view of the Carriage Platform in FIG. 19 with the vertical platform removed, the vertical platform in an adjustable carriage platform is designed to hinge down toward the horizontal platform or out away from the horizontal to better conform to the article needing mobility, the vertical platform can also be removed or placed in any other configuration to provide a flexible custom fit to the article needing mobility.

FIG. 20 is a side view of an adjustable Carriage Platform

FIG. 20B is a side view of an adjustable Carriage Platform inverted to allow it to be placed the upper plane of an article needing mobility.

FIG. 20C is a side view of an adjustable Carriage Platform with a wheel structure attached to the vertical platform to assist in mobility in all directions.

FIG. 21 a perspective view of two see through articles that are placed off center of each other with one Carriage Platform assembly holding the two articles together allowing the strapping device to hold the carriage platforms at the edge of the lower article to assist in the mobility of both articles.

FIG. 22 a perspective see through view of a large article needing mobility with the placement of two Carriage Platform Assemblies to better distribute the articles weight and help control the article size during movement.

FIG. 22B a perspective view of a large article needing mobility with the placement of two Carriage Platform Assemblies to better distribute the articles weight and help control the article size during movement.

FIG. 23 a perspective view of a irregular shaped article needing mobility, articles of all shapes and sizes can use the invention to assist movement.

FIG. 23B a perspective view of an irregular shaped article needing mobility with two Carriage Platform Assemblies positioned to better distribute article weight and size, one strapping device with an auxiliary loop handle to help control direction of the article during movement.

FIG. 23C a perspective view of an irregular shaped article needing mobility with two Carriage Platform Assemblies positioned to better distribute article weight and size, each strapping device with an auxiliary loop handle to help control direction of the article during movement. And provide the push pull force needed to move the article.

FIG. 23D a perspective view of an irregular shaped article needing mobility with two Carriage Platform Assemblies positioned to better distribute article weight and size, to help control direction of the article during movement.

FIG. 24 the article in FIG. 23c at the base of a stair case.

FIG. 24B the article in FIG. 24 being lifted to move above the stairs to illustrate the Carriage Platform Assemblies ability to remain securely wrapped around the article when lifted off the ground to clear a barrier or move vertically to continue mobility.

FIG. 24C the article in FIG. 24 at the top of the stairs to illustrate the Carriage Platform Assemblies ability to remain securely wrapped around the article when lifted off the ground to clear a barrier or move vertically to continue mobility.

FIG. 25 view of a cylindrical article needing mobility with two Carriage Platforms Assemblies positioned to provide mobility, one strapping device of the invention has an auxiliary loop handle to aid in the movement and direction of the cylindrical article.

FIG. 26 perspective view of a group of articles with a panel profile positioned in a vertical plane needing mobility, with two Carriage Platforms Assemblies positioned to provide mobility, one strapping device of the invention has an auxiliary loop handle to aid in the movement and direction of the grouped articles.

FIG. 27 perspective view of a multi plane irregular shaped article requiring mobility, with three Carriage Platforms Assemblies positioned to provide mobility and to assist movement in all directions.

FIG. 28 perspective view of four articles stacked together requiring mobility, with three Carriage Platforms Assemblies positioned to provide mobility and to assist movement in all directions.

FIG. 29 perspective view of an article that has been rolled up requiring mobility, with a Carriage Platforms Assemblies with one wheel structure positioned to assist mobility when the article is lifted from the opposite end the article can be pushed or pulled to provide movement.

FIG. 29B perspective view of an article that has been rolled up requiring mobility, with two Carriage Platforms Assemblies each with one or two carriage platforms each with a wheel structure positioned to provide mobility when article is pushed or pulled along a surface.

FIG. 30 view of an article requiring mobility, mobility being provide with a traditional hand truck with its transport angle, and the same article with Carriage Platform Assemblies that allow the article to be moved in any direction without any transport angle.

### DETAILED DESCRIPTION OF THE INVENTION

The invention is therefore directed to a Carriage Platform Assembly with its strapping device that securely holds the carriage platform and a wheel or wheel like structure to an article requiring mobility. Turning now to a description of the components illustrated in the drawing figures, which is thereafter followed by a discussion of how these various components work together in the invention,

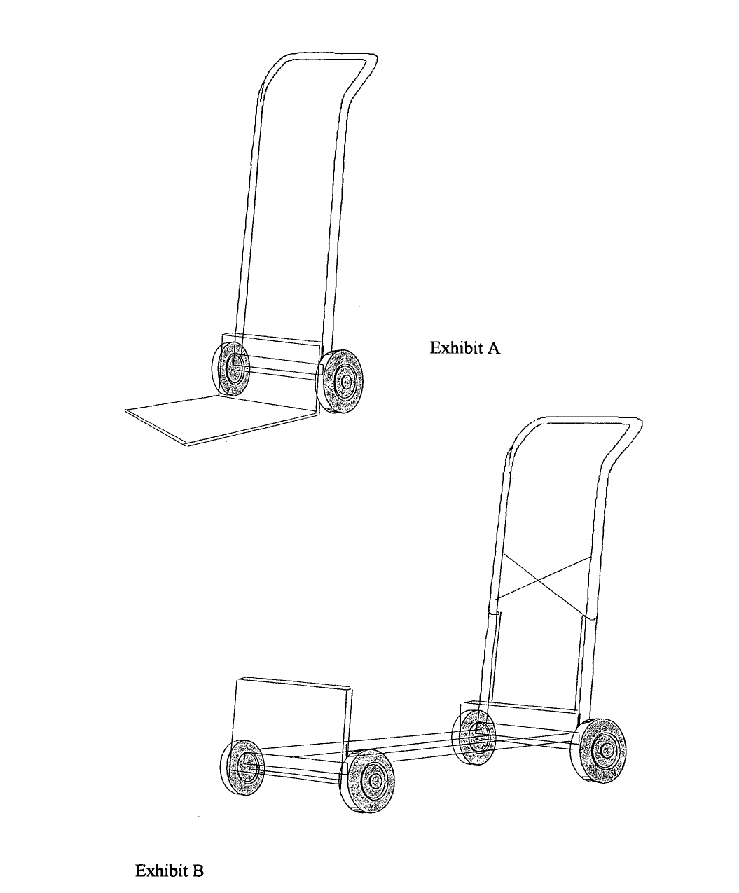

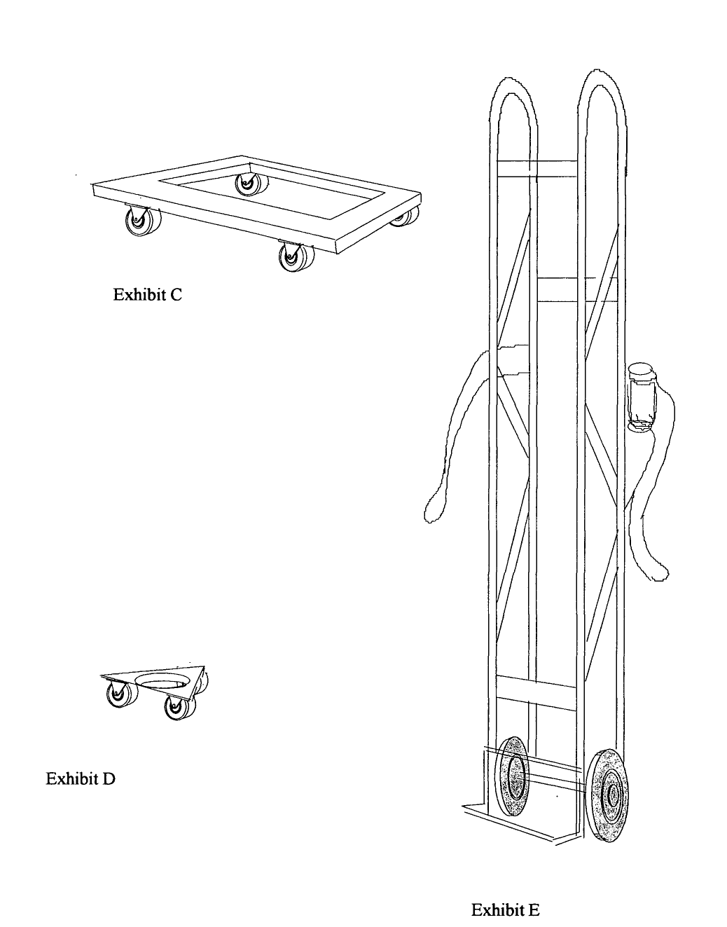

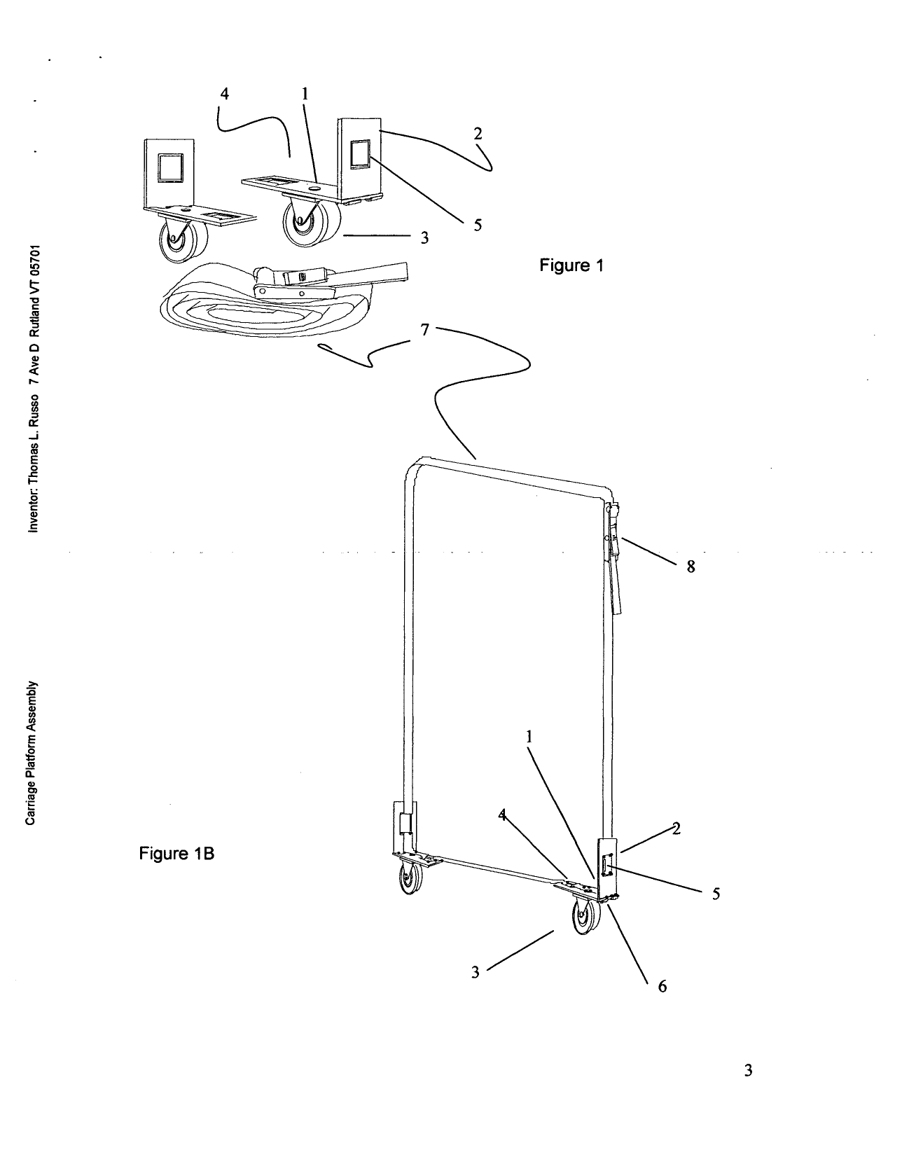

FIG. 1 illustrates a perspective view of the components of a Carriage Platform Assembly with two carriage platform with wheel structures, the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform, in the horizontal strapping connection (4), carriage platform is secured to the article needing mobility with a strapping or banding device (7), that is secured to the vertical carriage platform, in the vertical strapping connection (5), the strapping or banding device (7), holds the carriage platform(s) in place on the article requiring mobility using the article itself as the structure that holds the carriage platform and wheel structures in a position to assist and allow mobility of the article.

FIG. 1B illustrates a perspective view of the components of a Carriage Platform Assembly with two carriage platform with wheel structures placed together as if they were to surround an article of that shape and size requiring mobility, the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform, in the horizontal strapping connection (4), carriage platform is secured to the article needing mobility with a strapping or banding device (7), that is secured to the vertical carriage platform, in the vertical strapping connection (5), adjustable Carriage Platforms have a adjustable/removable vertical platform connection (6), allowing the vertical carriage platform to be hinged in or out to better fit the article shape requiring mobility, or be removed completely to better conform to the article shape, the strapping or banding device (7), holds the carriage platform(s) in place on the article requiring mobility using the article itself as the structure that holds the carriage platform and wheel structures in a position to assist and allow mobility of the article, the strapping or banding device can support a tightening and/or locking element (8), to allow the Carriage Platform Assembly to be securely held in position and also allow for added flexibility in sizing the strapping or banding device and provide for strapping or banding removal or replacement on one article, and allows the invention to be used over and over again on the same or different articles needing mobility.

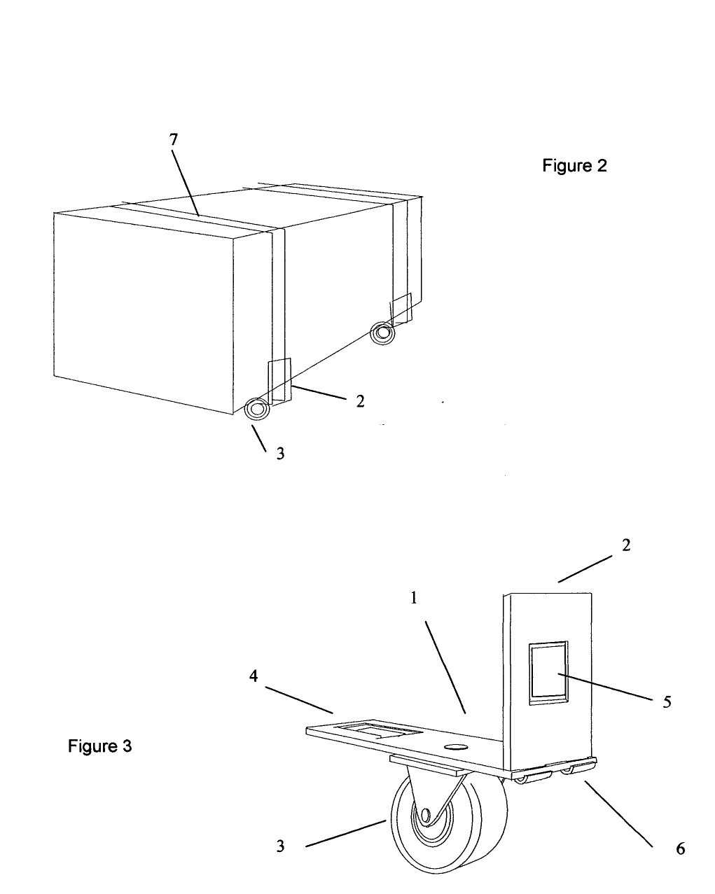

FIG. 2 illustrates a perspective view of an article to be moved using two Carriage Platform Assemblies with their wheel structures and strapping devices to surround the article requiring mobility, the figure detail is as follows, vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), the strapping or banding device (7), holds the carriage platform(s) in place on the article requiring mobility using the article itself as the structure that holds the carriage platform and wheel structures in a position to assist and allow mobility of the article.

FIG. 3 illustrates a perspective view of the carriage platform components, the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device, that is secured to the horizontal carriage platform, in the horizontal strapping connection (4), carriage platform is secured to the article needing mobility with a strapping or banding device, that is secured to the vertical carriage platform, in the vertical strapping connection (5), adjustable Carriage Platforms have a adjustable/removable vertical platform connection (6), allowing the vertical carriage platform to be hinged in or out to better fit the article shape requiring mobility, or be removed completely to better conform to the article shape, and allow mobility of the article.

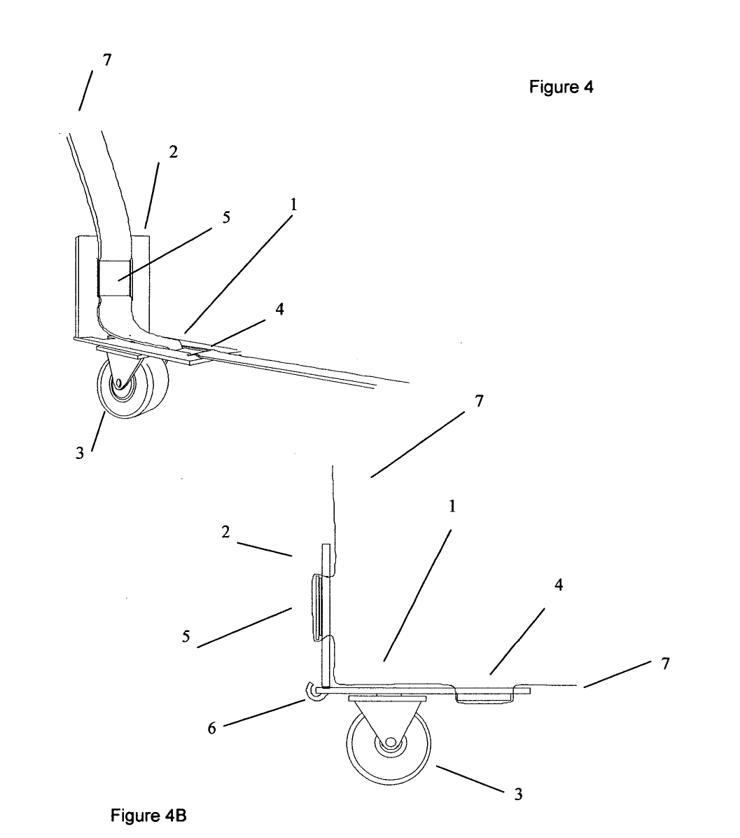

FIG. 4 illustrates a perspective inside view of the components of a Carriage Platform Assembly with carriage platform, wheel structure and strapping or banding device attached to vertical and horizontal carriage platform connections, the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform, in the horizontal strapping connection (4), carriage platform is secured to the article needing mobility with a strapping or banding device (7), that is secured to the vertical carriage platform, in the vertical strapping connection (5), the strapping or banding device (7), holds the carriage platform(s) in place on the article requiring mobility using the article itself as the structure that holds the carriage platform and wheel structures in a position to assist and allow mobility of the article.

FIG. 4B illustrates a side view of the components of an adjustable Carriage Platform Assembly with carriage platform, wheel structures and strapping device, the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform, in the horizontal strapping connection (4), carriage platform is secured to the article needing mobility with a strapping or banding device (7), that is secured to the vertical carriage platform, in the vertical strapping connection (5), adjustable Carriage Platforms have a adjustable/removable vertical platform connection (6), allowing the vertical carriage platform to be hinged in or out to better fit the article shape requiring mobility, or be removed completely to better conform to the article shape, the strapping or banding device (7), holds the carriage platform (s) in place on the article requiring mobility using the article itself as the structure that holds the carriage platform and wheel structures in a position to assist and allow mobility of the article.

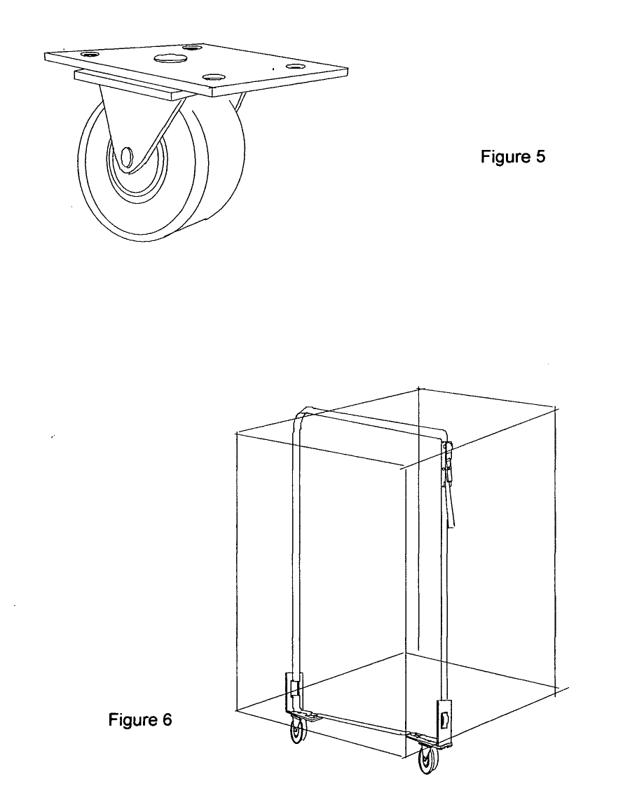

FIG. 5 perspective view of a representative wheel or wheel structure that is attached to a carriage platform to provide mobility. The invention provides for the attachment of any wheel, with complete rotation, swivel, fixed, locking or without locking features, in any shape that will facilitate mobility, in any material, example metal, wood, rubber, plastic, any know material that can be made or developed into a wheel or wheel structure that is known today or any created, made or developed in the future. Wheel like structure, can round like a ball, or bearing, cylindrical, tube shaped, disk shape and traditional wheel shape, any wheel design currently know and any wheel design of the future can be used in the present invention.

FIG. 6 illustrates a perspective see through view of an article with a single strapping device supporting two carriage platforms as describe in FIG. 1B above. This figure illustrates the placement of a Carriage Platform Assembly in a position forward on the article requiring mobility, movement can occur by lifting the end of the article behind the Carriage Platform Assembly and pushing forward or pulling backward to assist in providing movement.

FIG. 7 illustrates a strapping or banding material, the strapping or banding device (7), holds the carriage platform(s) in place on the article requiring mobility using the article itself as the structure that holds the carriage platform and wheel structures in a position to assist and allow mobility of the article, the strapping or banding device can support a tightening and/or locking element (8), to allow the Carriage Platform Assembly to be securely held in position and also allow for added flexibility in sizing the strapping or banding device and provide for strapping or banding removal or replacement on one article, and allows the invention to be used over and over again on the same or different articles needing mobility. The invention provides for the attachment of any strapping or banding device, in any shape that will facilitate holding and securing of the Carriage Platform in a carriage Platform Assembly, in any material, example metal, wood, rubber, plastic, glass fibers, plant fibers, mineral fibers, mined elements, any known material that can be made or developed into a strapping or banding material that is known today or any created, made or developed in the future. Strapping and banding, can be round, or cylindrical, tube shaped, flat, square, linked elements, web belting, rope, line, or plant fibers, firm, flexible, elastic, roll able, foldable, any strapping or banding material or device or shapes, or designs currently know and any strapping or banding materials or shapes or devices of the future can be used in the present invention. The tightening, locking or closing device can also be made of any known material in any design that will tighten and hold securely the Carriage Platform and wheel structures, it can be as simple as a loop or knot arrangement, or crimped, welded, or bonded together, or have a mechanical ratcheting or turn buckle like devices that will provide a holding element, and allow for removal or provide a permanent strapping arrangement. any known material or design of devices that will close, tighten or lock strapping or banding as described here in that can be made or developed into such a device in any material that is known today or any created, made or developed in the future can be used in this present invention.

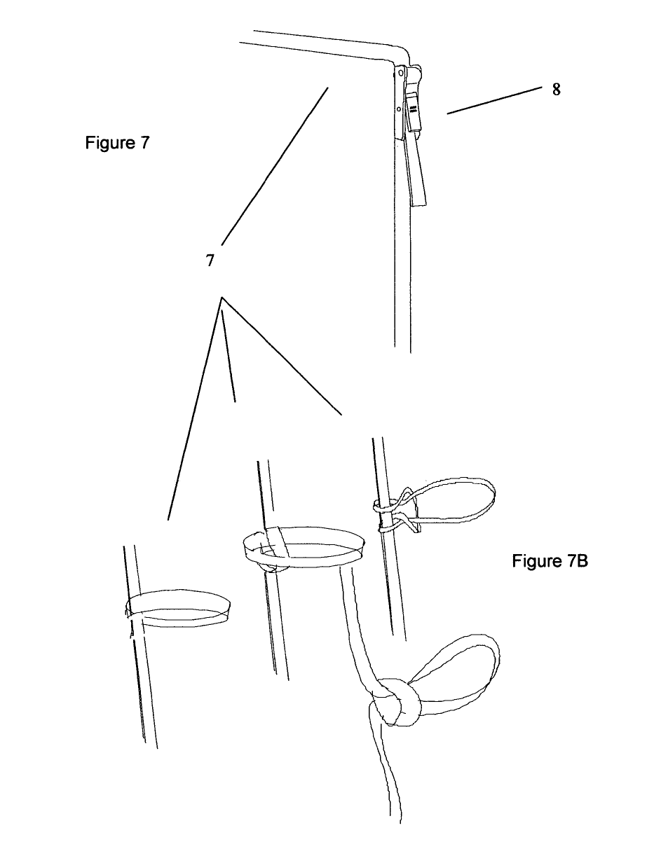

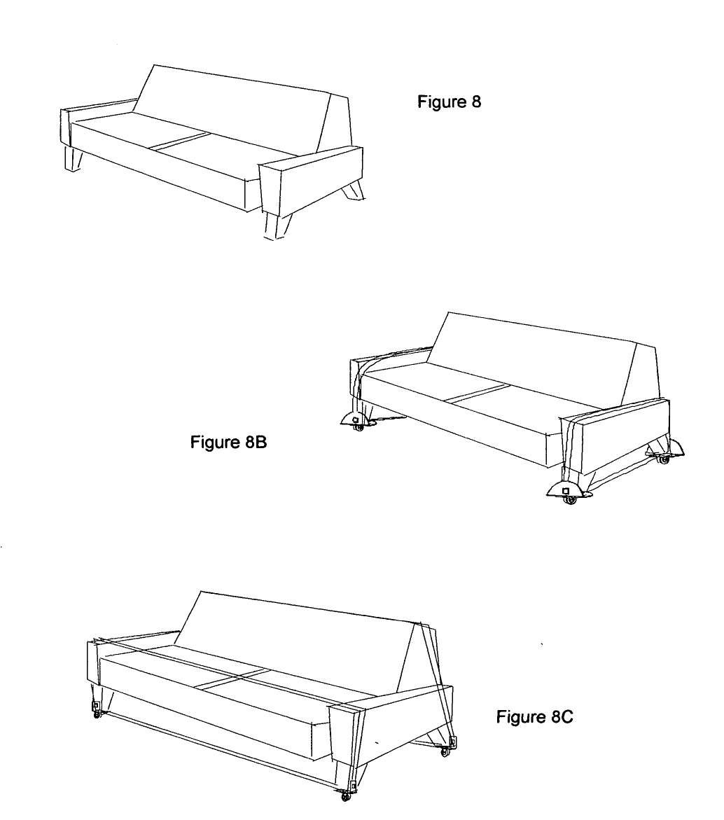

FIG. 8 illustrates a perspective view of a piece of furniture that represents an article that requires mobility. This item because of its apparent size and shape would be require a special arrangement of traditional mobility apparatus describe in Exhibit A, B, C, D, E, with the present invention one carriage platform with wheel structure can be placed under each leg of this article of furniture and held securely in place with the Carriage Platform Assemblies strapping or banding device.

FIG. 8B illustrates a perspective view of a piece of furniture of FIG. 8, that represents an article that requires mobility with the Carriage Platform Assembly connected front to back as one option to provide movement. With the Carriage Platform

FIG. 8C illustrates a perspective view of a piece of furniture, in FIG. 8, that represents an article that requires mobility with the Carriage Platform Assembly connected side to side as an other option to provide movement.

FIG. 9 illustrates a front and side view of a carriage platform formed of rod material providing an extended vertical platform with two vertical strapping connections and a sled like edge to assist in pulling an article up stairs or letting an article down stairs. This illustration presents a Carriage Platform where the horizontal and vertical carriage platforms are made as one unit, where the strapping material is placed between the horizontal platform and the wheel structure and then looped through the two vertical strapping connection in the vertical platform. This extended vertical platform with its sled like arrangement will assist in moving an article up and down stairs as the sled like edge rest against the stair riser and tread and the item is pulled to the next step, or let down to the step below, horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device, that is secured to the vertical carriage platform, in the vertical strapping connection (5), the structure that holds the carriage platform and wheel structures in a position to assist and allow mobility of the article.

FIG. 10 illustrates a front and side view of a low profile carriage platform that is designed to be attached to a strapping material allowing the strapping to move through the space between the horizontal platform and the wheel structure creating a sliding effect providing adjustability along the strapping length. The vertical platform helps stabilize the carriage platform assembly as it holds the carriage and wheel assembly on the article edges, reducing slippage as an article is pushed along, the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device, that is secured to the horizontal carriage platform, carriage platform is secured to the article needing mobility with a strapping or banding device (7), that is secured to the vertical carriage platform, in the strapping or banding device (7), holds the carriage platform(s) in place on the article requiring mobility using the article itself as the structure that holds the carriage platform and wheel structures in a position to assist and allow mobility of the article.

FIG. 11 illustrates the same carriage platform assembly arrangement described in FIG. 10 the only difference is a different wheel structure. As describe in FIG. 5 any wheel or wheel like structure can act in this invention. This is a front and side view of a low profile carriage platform that is designed to be attached to a strapping material allowing the strapping to move through the space between the horizontal platform and the wheel structure creating a sliding effect providing adjustability along the strapping length. The vertical platform helps stabilize the carriage platform assembly as it holds the carriage and wheel assembly on the article edges, reducing slippage as an article is pushed along, the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform, carriage platform is secured to the article needing mobility with a strapping or banding device (7), that is secured to the vertical carriage platform, the strapping or banding device (7), holds the carriage platform(s) in place on the article requiring mobility using the article itself as the structure that holds the carriage platform and wheel structures in a position to assist and allow mobility of the article

FIG. 12 illustrates a front, side and adjusted plan view of the carriage platform. To help illustrate that a bent rod carriage platform can be effective in a low profile allowing a slip on reverse side strapping connection, in this embodiment the carriage platform with its wheel structure can be removed from a strapping device or connected to a strapping device without any Carriage Platform in place the article can be stored or stacked with the strapping or banding device, then when mobility is needed the Carriage Platform can once again be connected to the strapping device that surrounds the article that was stored or stacked. The assembly left on and can be lifted over barriers and up or down stairs carried in any direction then returned to a surface and moved in any direction utilizing the present invention. the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform, carriage platform is secured to the article needing mobility with a strapping or banding device (7), that is secured to the vertical carriage platform, the strapping or banding device (7), holds the carriage platform (s) in place on the article requiring mobility using the article itself as the structure that holds the carriage platform and wheel structures in a position to assist and allow mobility of the article.

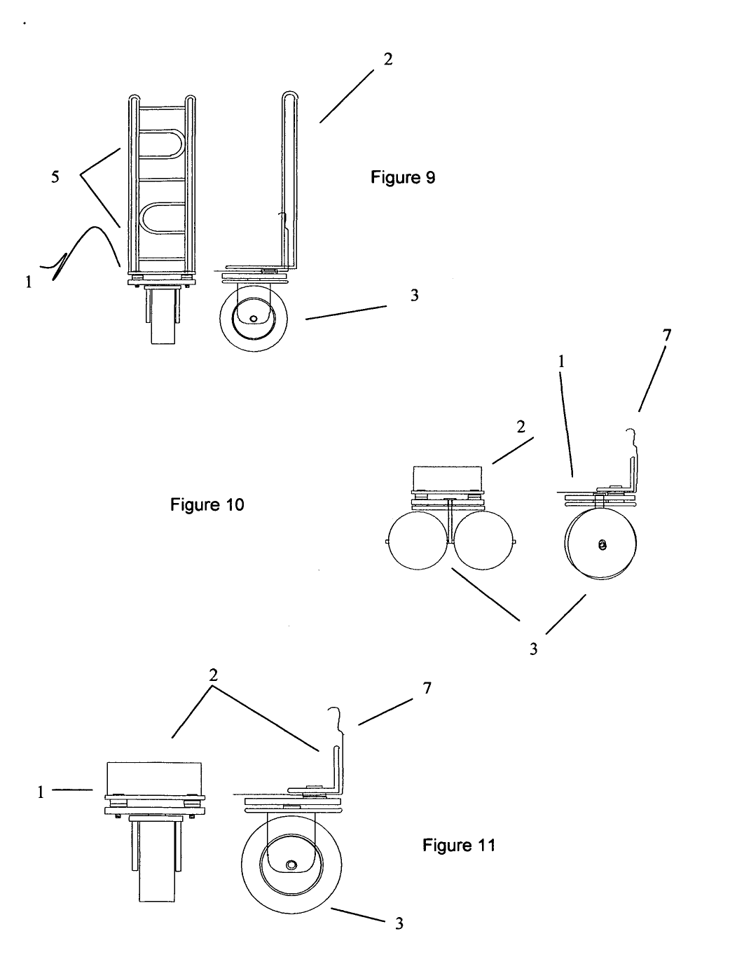

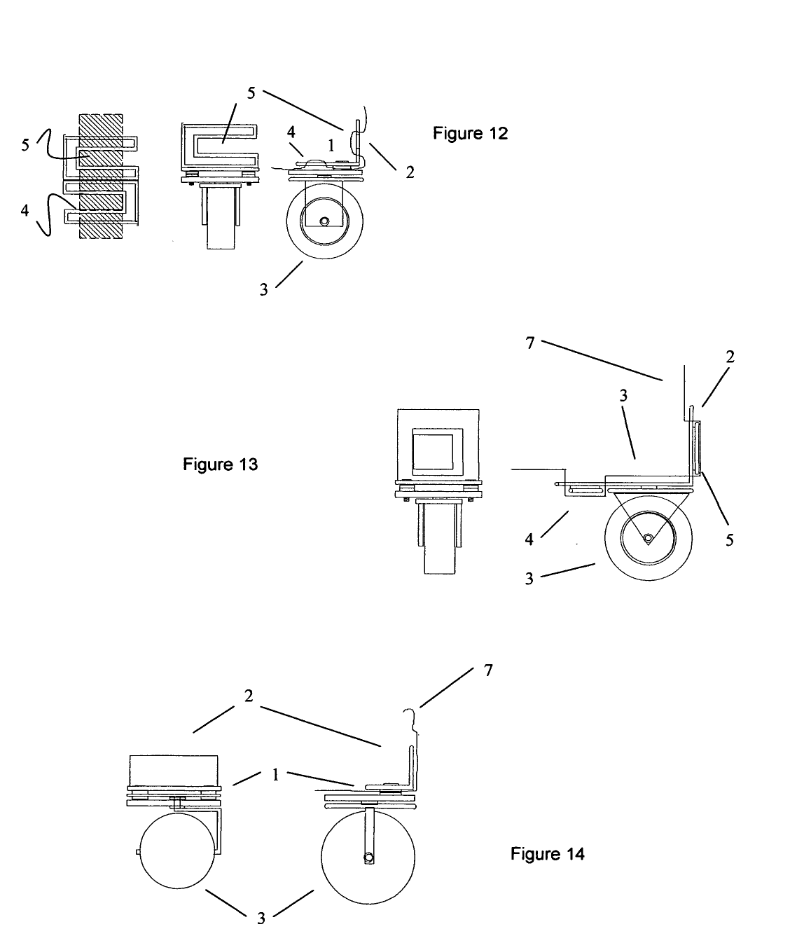

FIG. 13 illustrates a front, and side view of the carriage platform created of a formed material providing a permanent horizontal and vertical platform angle position. To help illustrate that a formed carriage platform can be effective in a low profile allowing a slip on reverse side strapping connection, in this embodiment the carriage platform with its wheel structure can be removed from a strapping device or connected to a strapping device without any tools, just by slipping the strapping into the strapping connections on both the horizontal and vertical platforms. the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform, in the horizontal strapping connection (4), carriage platform is secured to the article needing mobility with a strapping or banding device (7), that is secured to the vertical carriage platform, in the vertical strapping connection (5), the strapping or banding device (7), holds the carriage platform(s) in place on the article requiring mobility using the article itself as the structure that holds the carriage platform and wheel structures in a position to assist and allow mobility of the article.

FIG. 14 illustrates the same low profile carriage platform assembly as that described in FIGS. 10 and 11 with a different wheel structure. the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device (7), that is secured to the horizontal carriage platform carriage platform is secured to the article needing mobility with a strapping or banding device (7), that is secured to the vertical carriage platform, the strapping or banding device (7), holds the carriage platform(s) in place on the article requiring mobility using the article itself as the structure that holds the carriage platform and wheel structures in a position to assist and allow mobility of the article.

FIG. 15 illustrates a perspective view of a rod formed horizontal and vertical platforms that provide an attachment for a strapping or banding material with a cylindrical profile, all banding and strapping material can be used in the present invention. the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device, that is secured to the horizontal carriage platform, in the horizontal strapping connection (4), carriage platform is secured to the article needing mobility with a strapping or banding device, that is secured to the vertical carriage platform, in the vertical strapping connection (5) the strapping or banding device, holds the carriage platform (s) in place on the article requiring mobility using the article itself as the structure that holds the carriage platform and wheel structures in a position to assist and allow mobility of the article.

FIG. 15B illustrates a cylindrical banding or strapping material (9), in place in the carriage platform of FIG. 15.

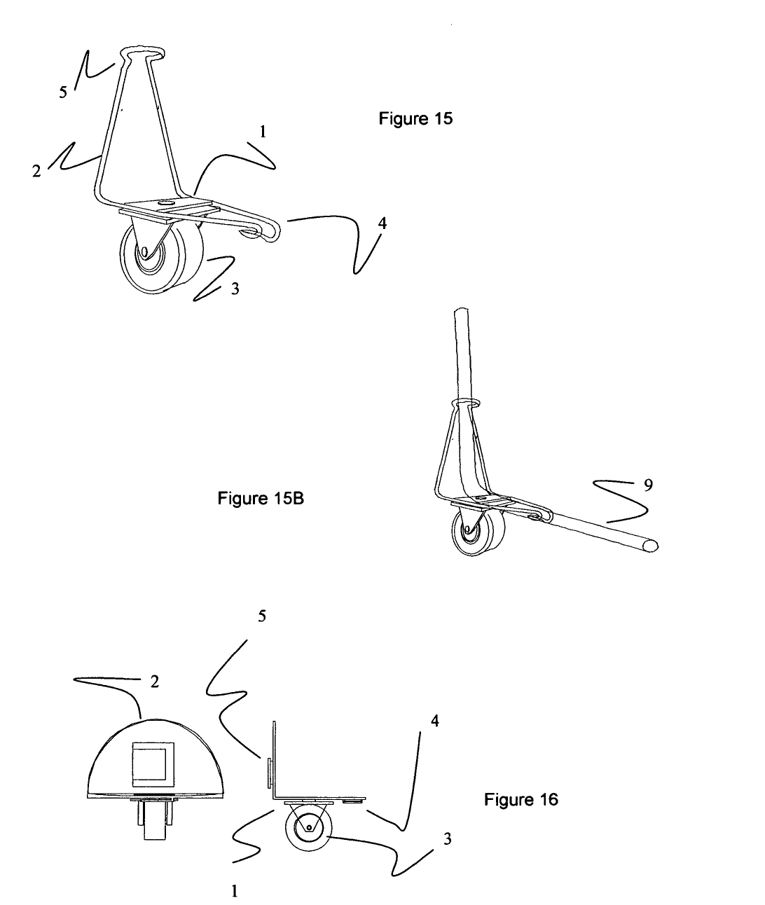

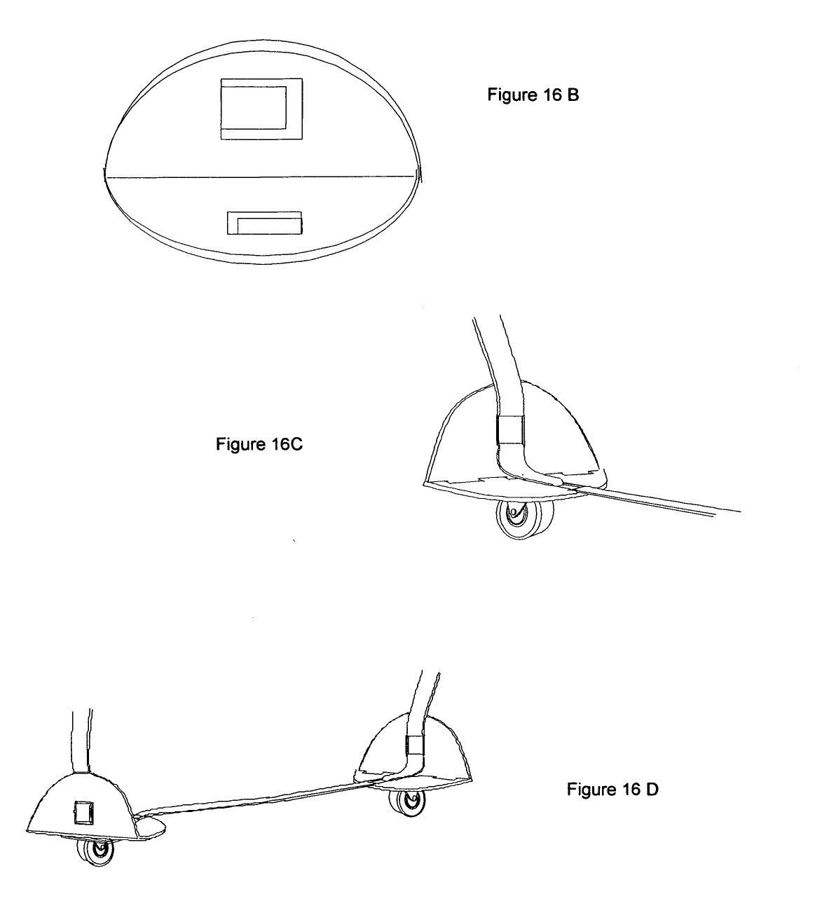

FIG. 16 is a front and side view of a carriage platform in a semi circle shape to help illustrate that the carriage platform can be created with an unlimited number of shapes and sizes. the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device, that is secured to the horizontal carriage platform, in the horizontal strapping connection (4), carriage platform is secured to the article needing mobility with a strapping or banding device, that is secured to the vertical carriage platform, in the vertical strapping connection (5), the strapping or banding device, holds the carriage platform in place on the article requiring mobility using the article itself as the structure that holds the carriage platform and wheel structures in a position to assist and allow mobility of the article.

FIG. 16B provides a modified top view of the semi circle carriage platform assembly.

FIG. 16 C shows FIG. 16 in a perspective view with its strapping connection in the horizontal and vertical platforms

FIG. 16D is a perspective view of the carriage platform assembly in FIG. 16C attached to a second carriage platform as they would be positioned under an article requiring mobility.

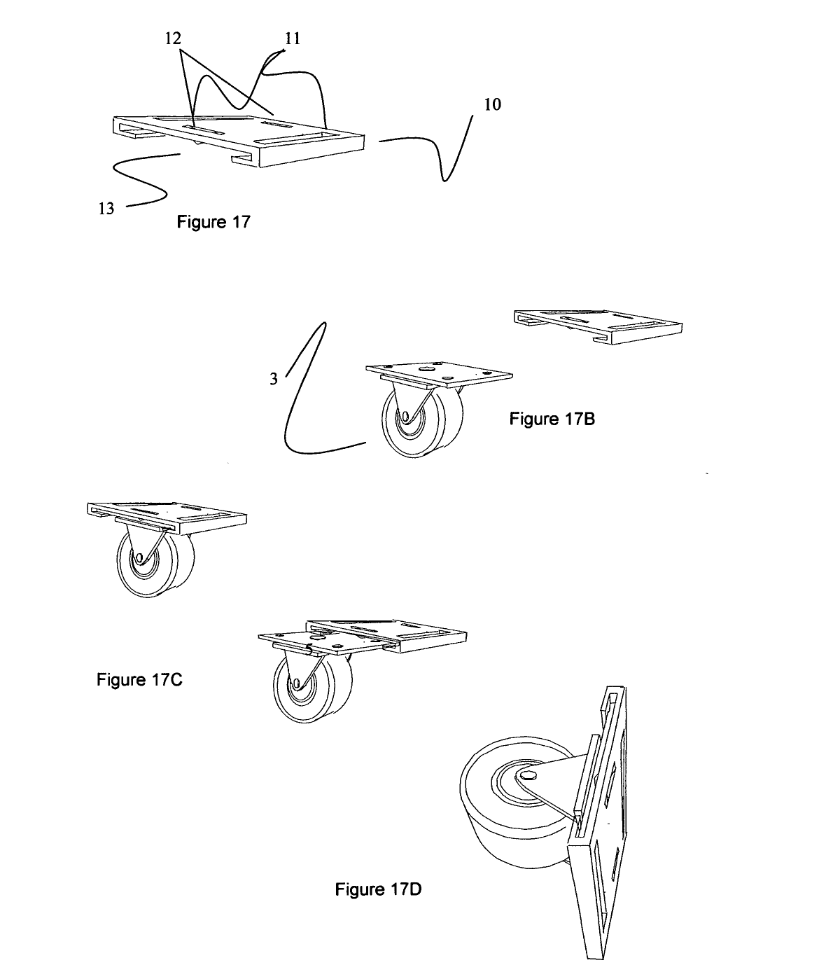

FIG. 17 illustrates a perspective view of a carriage platform that is designed for a removable wheels and wheel-like structures, allowing the carriage platform to be both a horizontal or a vertical platform (10) to be left in place around the article without its wheel structure when mobility is not required, held in place by the strapping or banding device, placed through the banding or strapping slots (11), when mobility is required a wheel structure is inserted in the platform (10) and held in place with the wheel structure placement push locks (12), slide the wheel structure into the wheel structure channel (13), it will snap in place between the placement push locks (12), of the carriage platform (10).

FIG. 17B illustrates a perspective view of a carriage platform described in FIG. 17, with a wheel structure (3), that can be inserted into the wheel structure channel (13), described in FIG. 17, to provide mobility.

FIG. 17C illustrates a perspective view of a carriage platform described in FIG. 17, with a wheel structure inserted to provide mobility, and a perspective view with a wheel structure being removed from the Carriage Platform (10) described in FIG. 17.

FIG. 17D illustrates a perspective view of a Carriage Platform described in FIG. 17, with a wheel structure inserted on a vertical plane, the invention can provide mobility on the horizontal plane to move an article across a surface, and on the vertical plane to help provide movement up or down stairs or moving an article vertically to assist mobility.

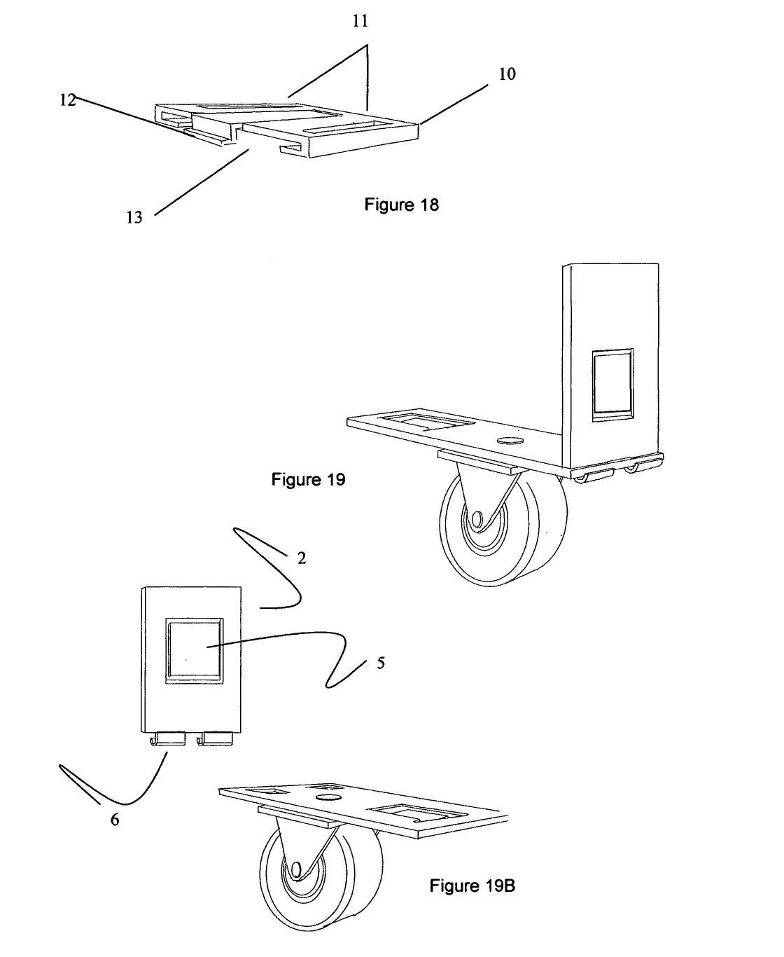

FIG. 18 is a perspective view of another carriage platform that is designed for a removable wheels and wheel-like structures, allowing the carriage platform to be left in place around the article without its wheel structure when mobility is not required, held in place by the strapping or banding device, when mobility is required a wheel structure is inserted in the platform. The invention lends itself to unlimited designs or embodiments that allow a wheel structure to be attached to an article needing mobility, allowing the carriage platform to be both a horizontal or a vertical platform (10), to be left in place around the article without its wheel structure when mobility is not required, held in place by the strapping or banding device, placed through the banding or strapping slots (11), when mobility is required a wheel structure is inserted in the platform (10) and held in place with the wheel structure placement push locks (12), slide the wheel structure into the wheel structure channel (13), it will snap in place between the placement push locks (12), of the carriage platform (10).

FIG. 19 illustrates a perspective view of an adjustable Carriage Platform with an attached wheel structure, as described in FIG. 3

FIG. 19B illustrates a perspective view of the Carriage Platform in FIG. 19 with the vertical platform removed (2), the vertical platform in an adjustable carriage platform is designed to hinge down or in toward the horizontal platform or out away from the horizontal to better conform to the article needing mobility, the vertical platform can also be removed or placed in any other configuration to provide a flexible custom fit to the article needing mobility.

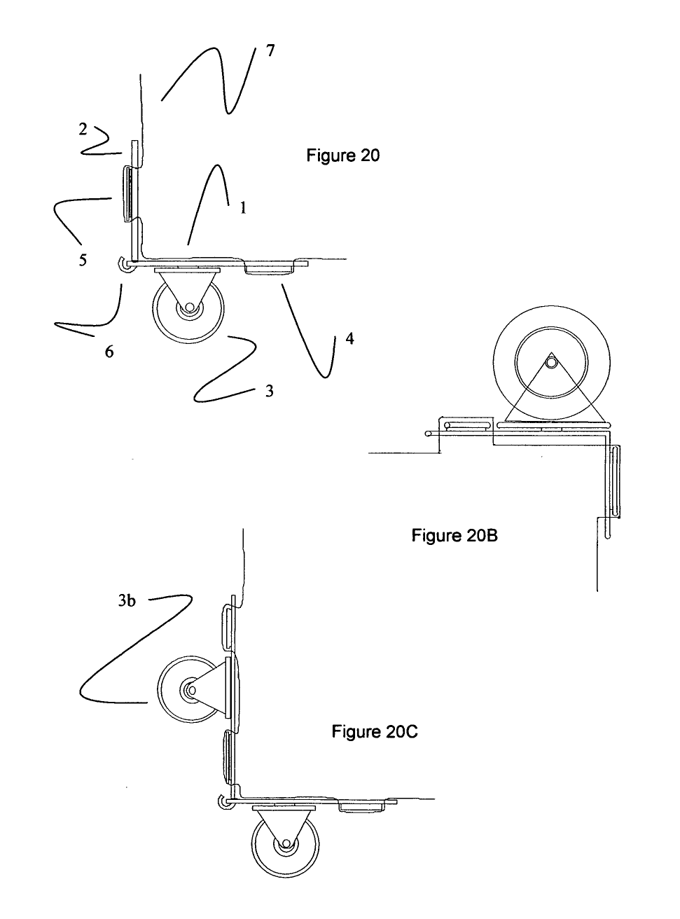

FIG. 20 illustrates a side view of an adjustable Carriage Platform the figure detail is as follows; horizontal carriage platform where a horizontal surface of the article requiring mobility can be placed (1), vertical carriage platform where a vertical surface of the article requiring mobility can be placed (2), a wheel or wheel like structure that is attached to a carriage platform providing mobility (3), that carriage platform is secured to the article needing mobility with a strapping or banding device, that is secured to the horizontal carriage platform, in the horizontal strapping connection (4), carriage platform is secured to the article needing mobility with a strapping or banding device, that is secured to the vertical carriage platform, in the vertical strapping connection (5), adjustable Carriage Platforms have a adjustable/removable vertical platform connection (6), allowing the vertical carriage platform to be hinged in or out to better fit the article shape requiring mobility, or be removed completely to better conform to the article shape, and allow mobility of the article.

FIG. 20B illustrates a side view of an adjustable Carriage Platform described in FIG. 20 inverted to allow it to be placed the upper plane of an article needing mobility.

FIG. 20C illustrates a side view of an adjustable Carriage Platform described in FIG. 20 with a wheel structure (3b), attached to the vertical platform to assist in mobility in all directions.

FIG. 21 a perspective view of two see through articles that are placed off center of each other with one Carriage Platform assembly holding the two articles together allowing the strapping device to hold the carriage platforms at the edge of the lower article to assist in the mobility of both articles. By holding the upper article in a balanced position both articles can be pushed or pulled along a surface in any direction.

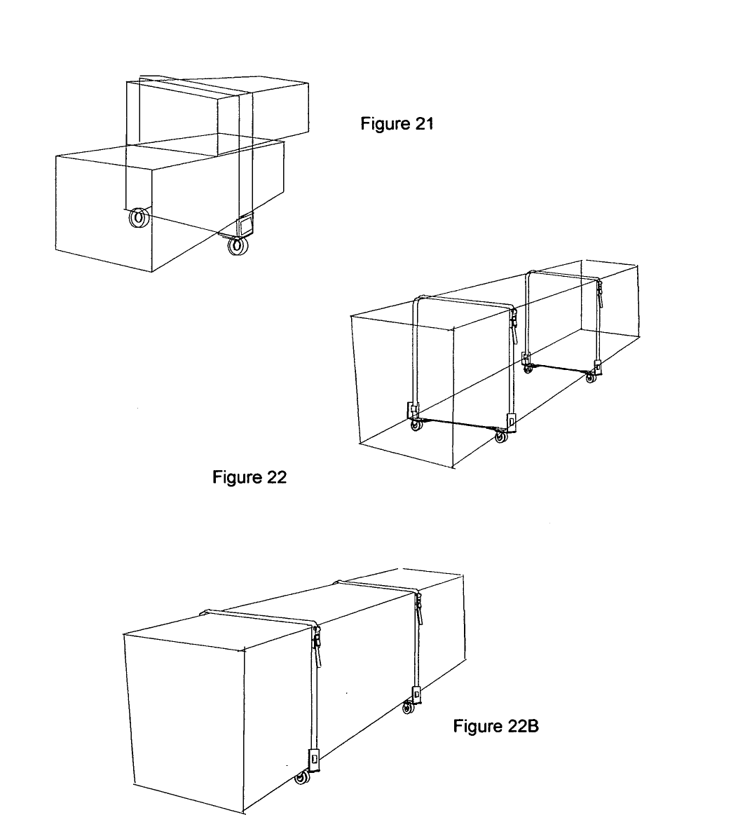

FIG. 22 a perspective see through view of a large article needing mobility with the placement of two Carriage Platform Assemblies to better distribute the articles weight and help control the article size during movement. With the weight distributed using two carriage platform wheel assemblies moving the article with a push or pull force can provide mobility

FIG. 22B a perspective view of a large article needing mobility with the placement of two Carriage Platform Assemblies to better distribute the articles weight and help control the article size during movement. With the weight distributed using two carriage platform wheel assemblies moving the article with a push or pull force can provide mobility

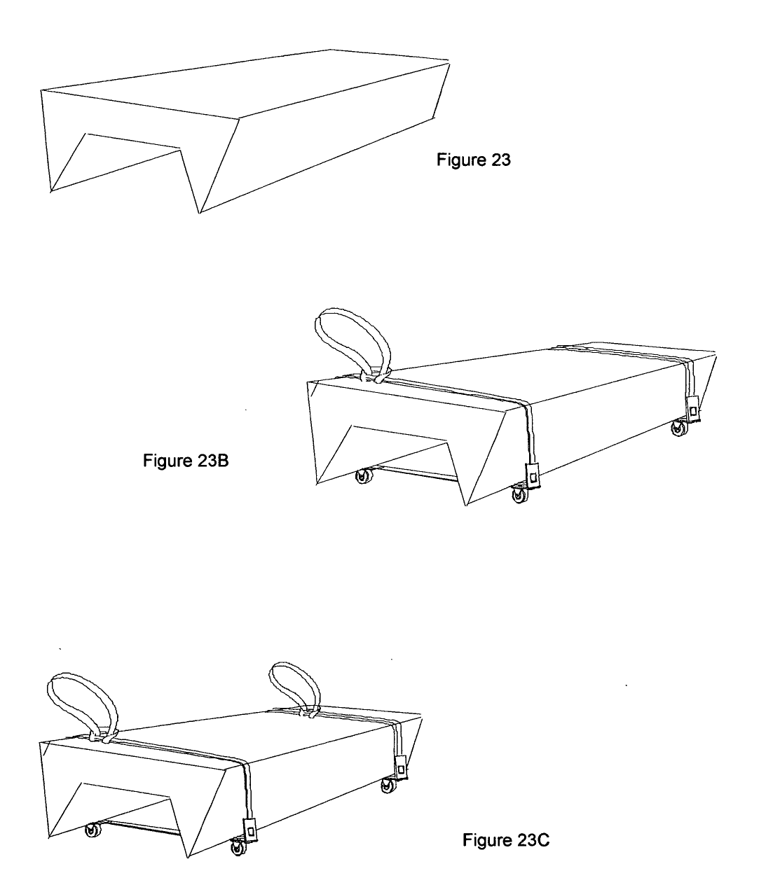

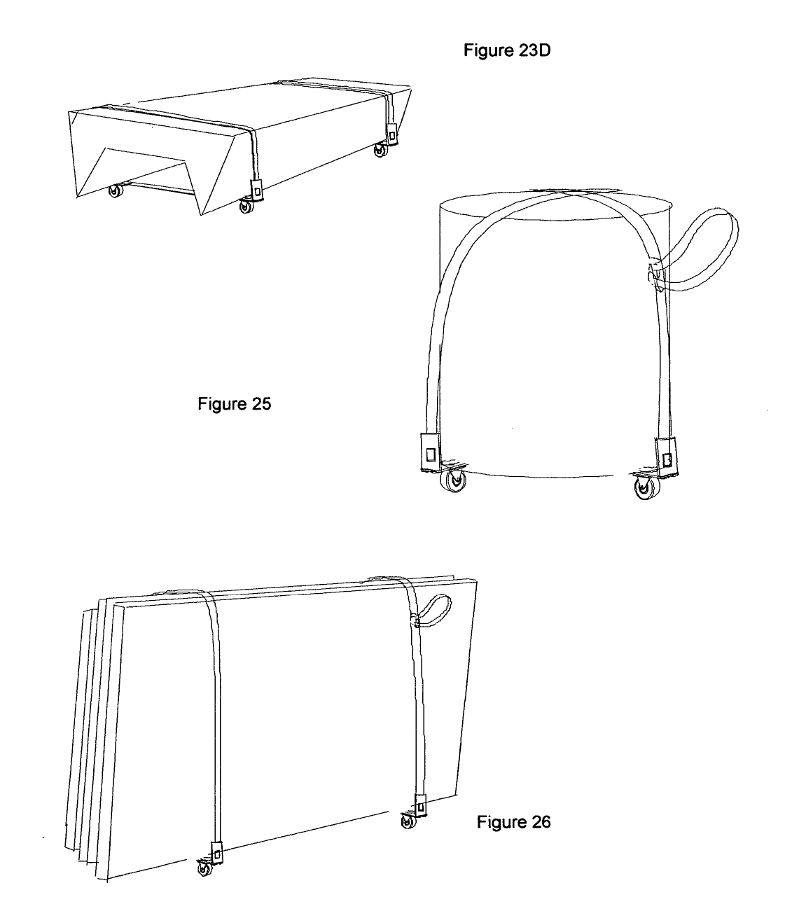

FIG. 23 a perspective view of a irregular shaped article needing mobility, articles of all shapes and sizes can use the invention to assist movement.

FIG. 23B a perspective view of an irregular shaped article needing mobility with two Carriage Platform Assemblies positioned to better distribute article weight and size, one strapping device with an auxiliary loop handle to help control direction of the article during movement.

FIG. 23C a perspective view of an irregular shaped article needing mobility with two Carriage Platform Assemblies positioned to better distribute article weight and size, each strapping device with an auxiliary loop handle to help control direction of the article during movement. And provide the push pull force needed to move the article.

FIG. 23D a perspective view of an irregular shaped article needing mobility with two Carriage Platform Assemblies positioned to better distribute article weight and size, to help control direction of the article during movement.

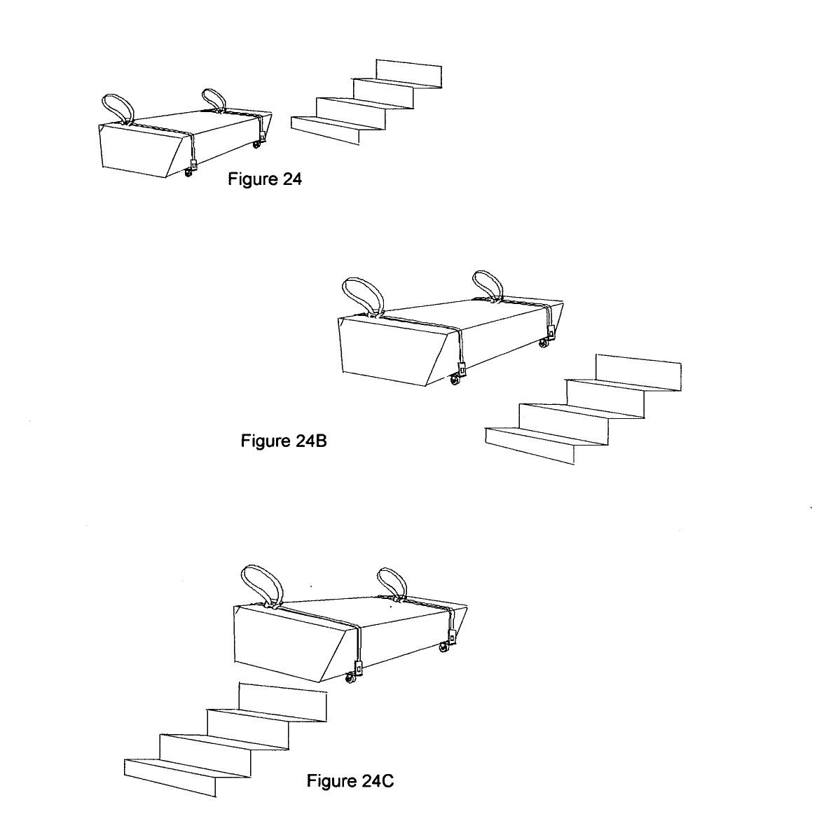

FIG. 24 the article in FIG. 23c at the base of a stair case.

FIG. 24B the article in FIG. 24 being lifted to move above the stairs to illustrate the Carriage Platform Assemblies ability to remain securely wrapped around the article when lifted off the ground to clear a barrier or move vertically to continue mobility.

FIG. 24C the article in FIG. 24 at the top of the stairs to illustrate the Carriage Platform Assemblies ability to remain securely wrapped around the article when lifted off the ground to clear a barrier or move vertically to continue mobility.

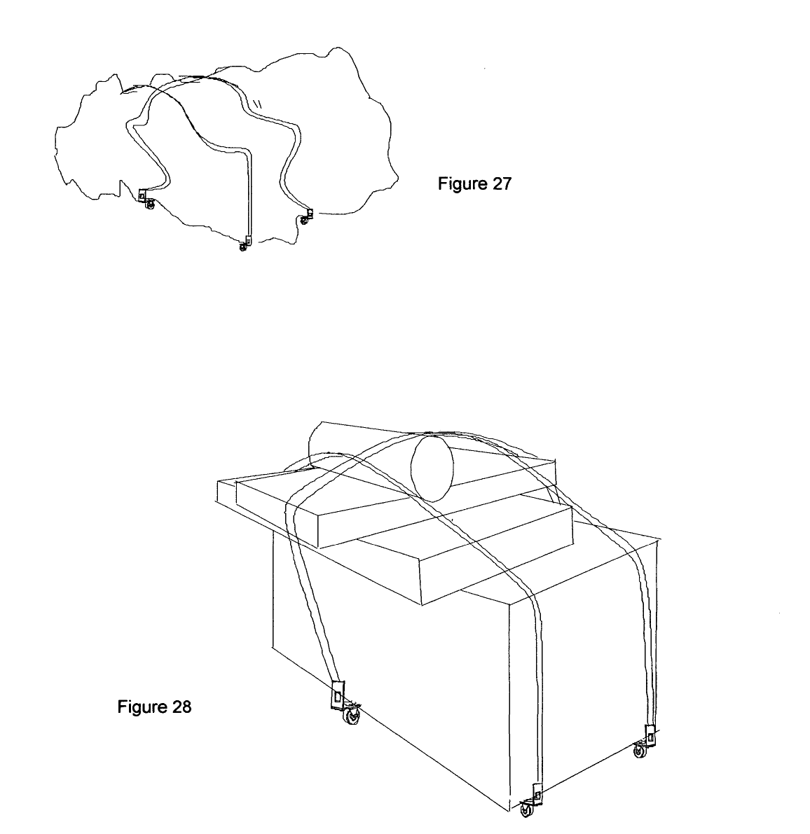

FIG. 25 view of a cylindrical article needing mobility with two Carriage Platforms Assemblies positioned to provide mobility, one strapping device of the invention has an auxiliary loop handle to aid in the movement and direction of the cylindrical article.

FIG. 26 perspective view of a group of articles with a panel profile positioned in a vertical plane needing mobility, with two Carriage Platforms Assemblies positioned to provide mobility, one strapping device of the invention has an auxiliary loop handle to aid in the movement and direction of the grouped articles.

FIG. 27 perspective view of a multi plane irregular shaped article requiring mobility, with three Carriage Platforms Assemblies positioned to provide mobility and to assist movement in all directions.

FIG. 28 perspective view of four articles stacked together requiring mobility, with three Carriage Platforms Assemblies positioned to provide mobility and to assist movement in all directions.

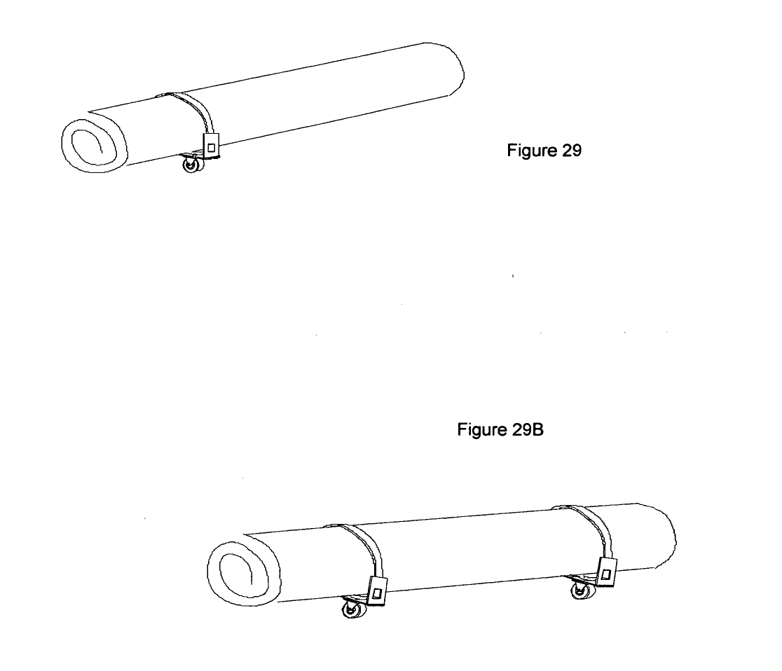

FIG. 29 perspective view of an article that has been rolled up requiring mobility, with a Carriage Platform Assembly with one wheel structure positioned to assist mobility when the article is lifted from the opposite end the article can be pushed or pulled to provide movement.

FIG. 29B perspective view of an article that has been rolled up requiring mobility, with two Carriage Platform Assemblies each with one or two carriage platforms each with a wheel structure positioned to provide mobility when article is pushed or pulled along a surface.

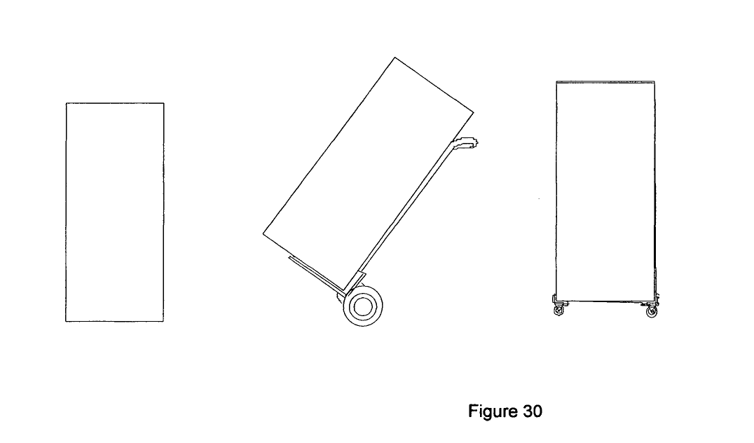

FIG. 30 view of an article requiring mobility, mobility being provide with a traditional hand truck with its transport angle, and the same article with Carriage Platform Assemblies that allow the article to be moved in any direction without any transport angle.

As shown in the accompanying drawing figures, the present system includes everything needed to provide article mobility without a framed structure to position wheels below the article needing mobility. It is therefore an object of the invention to provide temporary or extended or permanent article mobility.

The system of the inventions is a Carriage Platform Assembly that allows a single wheel or wheel like structure to assist article mobility as it provides a flexible structure that is secured to the article requiring mobility with a banding or strapping device that develops the article requiring mobility as the custom frame work, FIG. 2, of the Carriage Platform Assembly, FIG. 1B.

It is therefore the direction of this invention a Carriage Platform Assembly, FIG. 1B, that incorporates a carriage platform, FIG. 3, in combination with strapping material that secure wheel or wheel like structures, FIG. 4, to a designated article providing a flexible and custom mobility without adding significant weight or dimension to the article needing mobility.

The application of a strapping element with a Carriage Platform provides several beneficial attributes allowing mobility to a wider range of articles. Strapping or banding can be applied to any article type, shape, or size. All strapping or banding elements materials and devices currently known as well as those developed in the future can be applied to the Carriage Platform, that will secure the article needing mobility to the wheel or wheel-like structure providing mobility.

It is to be understood that the present invention is not limited in scope by the exemplified embodiments which are intended as illustrations of single aspects of the invention, and the embodiments and methods which are functionally equivalent are within the scope of the invention. Indeed, various modifications of the invention in addition to those described herein will become apparent to those skilled in the art from the foregoing description.

What is claimed is:

1. Article mobility with the use of a Carriage Platform assembly that includes a Carriage platform with a wheel or wheel-like structure held securely around an article requiring mobility with a strapping or banding device.

2. Article mobility with the use of a Carriage Platform assembly provides a custom fit to the article requiring mobility taking the form of said article through the strapping or banding device that holds the Carriage Platform in place.

3. Article mobility with a corner to corner application, edge to edge application, horizontal or vertical application provided by the custom fit of the Carriage Platform assembly, adjustment achieved by placing a carriage platform along the length of strapping material that best fit the article to be moved.

4. Frameless the Carriage Platform assembly requires no ridge frame to allow an article to be held in place on the assembly while being moved
